(19) United States
(12) Patent Application Publication
(10) Pub. No.: US 2023/0218118 A1
(43) Pub. Date: Jul. 13, 2023

(54) HAND-WASHING STATION

(71) Applicant: Igloo Products Corp., Katy, TX (US)

(72) Inventors: Jeff Diamond, Torrance, CA (US); John Maldonado, Katy, TX (US); Brad Thompson, Houston, TX (US)

(21) Appl. No.: 18/001,208

(22) PCT Filed: Jun. 8, 2021
(86) PCT No.: PCT/US21/36316

§ 371 Date: Dec. 8, 2022

Related U.S. Application Data
(60) Provisional application No. 63/037,205, filed on Jun. 10, 2020.

(51) Int. Cl. A47K 1/02; B67D 3/04

(52) U.S. Cl. CPC A47K 1/02; B67D 3/04; A47K 2210/00

(57) ABSTRACT

Various examples are provided for a portable cooler hand-washing station. In one example, a portable cooler hand-washing station has a body with a base and a sidewall extending away from the base to form an opening at a distal end of the sidewall. The body defines a spigot opening at a lower portion of the body. A spigot is coupled to the body at the spigot opening and is adapted to be fluidly coupled to an interior of the body. A mounting bracket is coupled to the sidewall of the body. A caddy is adapted to be coupled to the mounting bracket.

### RELATED APPLICATIONS

The present application claims the benefit of priority to U.S. Provisional Application No. 63/037,205, entitled “HAND-WASHING STATION,” filed on Jun. 10, 2020, which is incorporated herein by reference in its entirety.

### TECHNICAL FIELD

The present disclosure relates generally to a hand-washing station, and more particularly to a portable cooler hand-washing station.

### BACKGROUND

Hand hygiene is an important, and sometimes overlooked, aspect of many environments and occupations. For example, hand hygiene can be a critical component of the routine for people at construction sites, farmers markets, church events, schoolyards, and youth sports fields. Further, it is important to encourage proper hand-washing and sanitizing in environments where running water from a municipal water source may not be readily available. Many conventional hand-washing solutions are not portable, or do not operate without a connection to a running water source. Improved methods, systems and devices for encouraging proper hand-washing and sanitizing would therefore be useful.

### SUMMARY

Disclosed herein are various portable cooler hand-washing stations to address the aforementioned deficiencies. In various aspects, a portable cooler hand-washing station can include a body with a base and a sidewall. The sidewall can extend orthogonally away from the base to form an opening at a distal end of the sidewall and define a cavity therein that is fluidly coupled to the opening. The body can further define a spigot opening at a lower portion of the body. A lid can be coupled to the body and enclose the cavity and the opening.

In one embodiment, among others, the portable cooler hand-washing station can include a mounting bracket coupled to the sidewall of the body. A caddy with a base and a sidewall can extend orthogonally away from edges of the base to form an opening at the distal end of the sidewall and define a caddy cavity therein that is fluidly coupled to the opening. The caddy cavity can accommodate at least one of a soap dispenser or a hand sanitizer. The caddy can be coupleable to the mounting bracket. The portable cooler hand-washing station can include a spigot with a lever controlling a flow of a fluid through the spigot, the spigot coupled to the body at the spigot opening and being fluidly coupled to an interior of the body. In some aspects, the lever is adapted to be physically actuated in a hands-free manner. In some examples, the lever is adapted to be flipped up to provide for flow of a fluid from within the cavity of the body through the spigot.

In another embodiment, a portable cooler hand-washing station includes a body with a base and a sidewall extending orthogonally away from the base to form an opening at a distal end of the sidewall and define a cavity therein that is fluidly coupled to the opening. The body can further define a spigot opening at a lower portion of the body. The portable cooler hand-washing station can include a lid being coupled to the body and enclosing the cavity and the opening.

The portable cooler hand-washing station includes a spigot coupled to the body at the spigot opening. In some aspects, the spigot is adapted to be fluidly coupled to an interior of the body. In examples, the spigot can be adapted to be fluidly coupled to the interior of the body through a liner. The spigot can include a lever adapted to control a flow of a fluid through the spigot.

In some examples, a mounting bracket is coupled to the sidewall of the body, and a caddy is adapted to be coupled to the mounting bracket. The caddy can be a substantially rectangular container. The caddy can define a caddy cavity that is adapted to accommodate at least one of a soap dispenser or a hand sanitizer.

The caddy can include an inner sidewall that is formed into a shape that complements an exterior shape of the sidewall of the body. In some example embodiments, the caddy being adapted to be coupled to the mounting bracket includes the inner sidewall having a caddy bracket that is adapted to couple the caddy to the mounting bracket in a sliding relationship. A bottom end of the caddy bracket can be adapted to be positioned over a top end of the mounting bracket. In some aspects, the bottom end of the caddy bracket is adapted to be slid downwardly along at least one elongated rail of the mounting bracket.

In some examples, a top end of the caddy bracket includes a caddy stop feature adapted to provide a stop so that the caddy is prevented from moving downwardly with respect to the mounting bracket when the caddy is coupled to the mounting bracket. The caddy stop feature can extend along the top end of the caddy bracket.

### BRIEF DESCRIPTION OF THE DRAWINGS

The foregoing and other features and aspects of the invention are best understood with reference to the following description of certain exemplary embodiments, when read in conjunction with the accompanying drawings, which are not necessarily drawn to scale.

FIG. 1 shows a perspective view of a portable cooler hand-washing station according to various embodiments of the present disclosure.

FIG. 2 shows a perspective view of the portable cooler hand-washing station of FIG. 1 with a caddy being disassembled according to various embodiments of the present disclosure.

FIG. 3A is a front view of the portable cooler hand-washing station of FIG. 1 according to various embodiments of the present disclosure.

FIG. 3B is a side view of the portable cooler hand-washing station of FIG. 1 according to various embodiments of the present disclosure.

FIG. 4 is a perspective exploded view of the portable cooler hand-washing station of FIG. 1 according to various embodiments of the present disclosure.

The drawings illustrate only exemplary embodiments of the invention and are therefore not to be considered limiting of its scope, as the invention may admit to other equally effective embodiments.

### DETAILED DESCRIPTION

The exemplary embodiment discussed herein is directed to various aspects (e.g., methods, systems, devices) of a hand-washing station, and more particularly to a portable cooler hand-washing station. In certain exemplary embodiments, the lid may be coupled to the top of the body in any number of ways, such as by use of a hinge and/or a latch. Further, the caddy may be of a different size or shape than described herein and may be coupled to the side of the body in a different manner than described herein. Further, the body of the portable cooler hand-washing station may be in one or more of a number of different cooler sizes with various lengths, widths, heights, geometrical and non-geometrical shapes and/or capacities. Further, in certain exemplary embodiments, the portable cooler hand-washing station may be fabricated using different colors, accents, and/or different personalizations, such as by laser etching or silk screening across one or more of its surfaces. Further, in certain exemplary embodiments, the portable cooler hand-washing station may be fabricated in various different materials, such as rubber, plastics, stainless steel, other polymers, and other metals in one or more fabricated parts of the portable cooler hand-washing station. Further, the portable cooler hand-washing station may include other known features including but not limited to wheels, lights, and speakers.

Exemplary embodiments of the portable cooler hand-washing station will now be described more fully hereinafter with reference to the accompanying drawings, in which an exemplary embodiment of the portable cooler hand-washing station is shown. The portable cooler hand-washing station may, however, be embodied in many different forms and should not be construed as limited to the exemplary embodiment set forth herein. Rather, this exemplary embodiment is provided so that this disclosure will be thorough and complete, and will fully convey the scope of the portable cooler hand-washing station to those or ordinary skill in the art. Like, but not necessarily the same, elements in the various figures are denoted by like reference numerals for consistency.

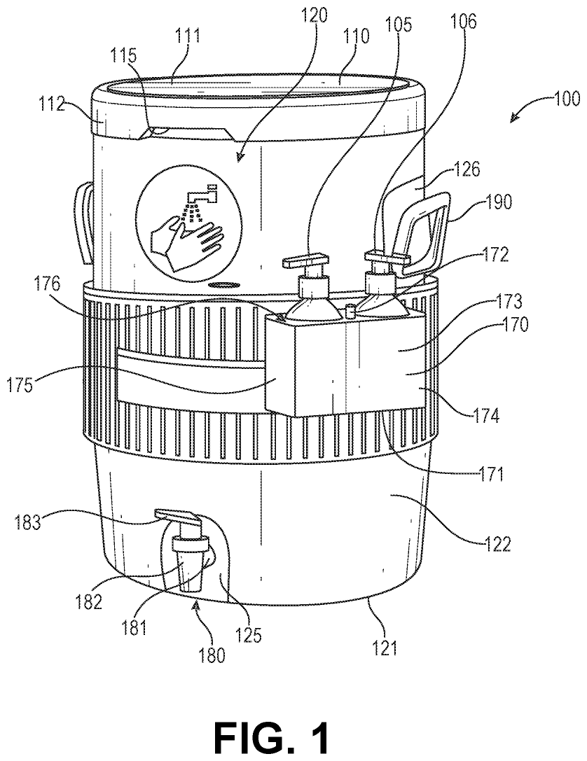

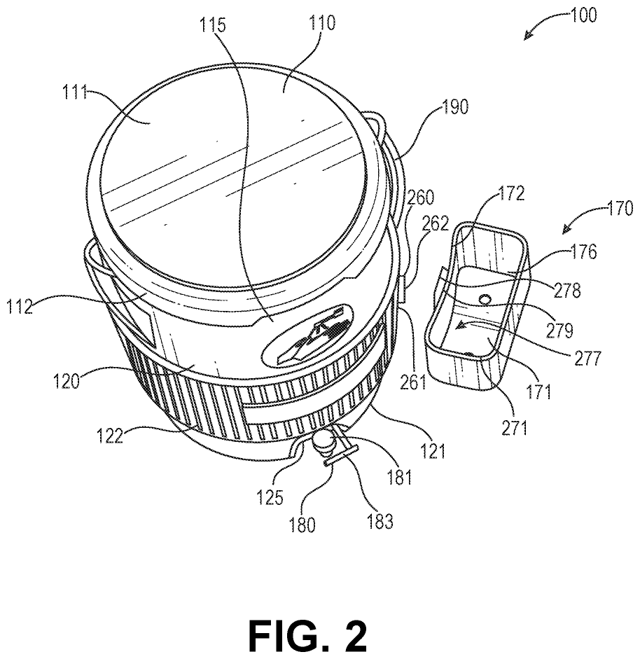

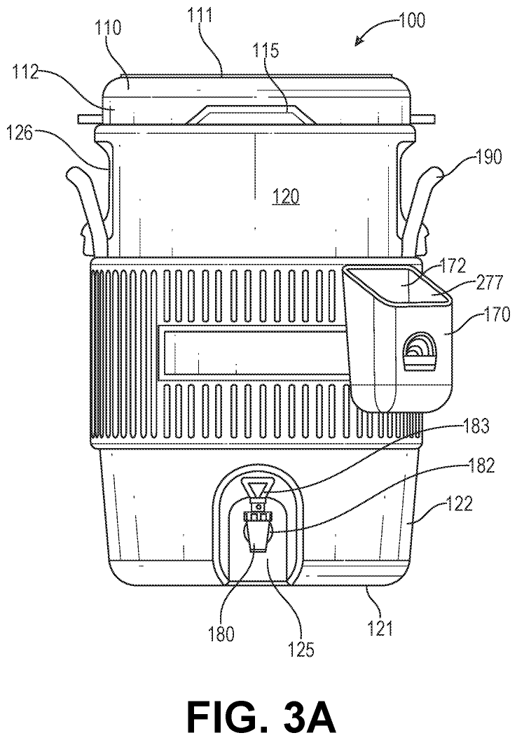

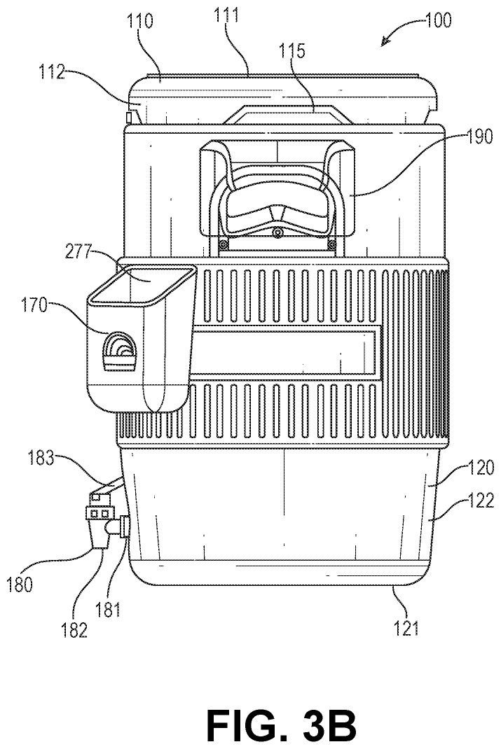

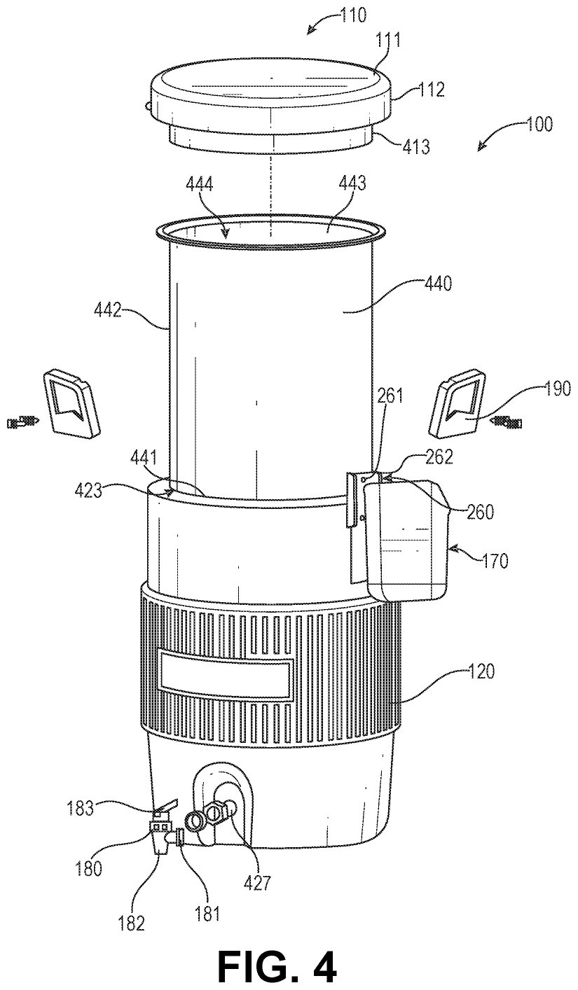

FIG. 1 shows a perspective view of a portable cooler hand-washing station 100 in accordance with various embodiments of the present disclosure. FIG. 2 show a perspective view of the portable cooler hand-washing station 100 of FIG. 1 with a caddy 170 being disassembled in accordance with various embodiments. FIG. 3A is a front view of the portable cooler hand-washing station 100 of FIG. 1 in accordance with various embodiments. FIG. 3B is a side view of the portable cooler hand-washing station 100 of FIG. 1 in accordance with various embodiments. FIG. 4 shows a perspective exploded view of the portable cooler hand-washing station 100 of FIG. 1 in accordance with various embodiments of the present disclosure.

Referring to FIGS. 1-4, the portable cooler hand-washing station 100 can include a body 120, a lid 110, a mounting bracket 260, a caddy 170, a spigot 180, or one or more handles 190. The body 120 is cylindrical in shape according to the exemplary embodiment but may be shaped in any other geometric or non-geometric shape in other embodiments. According to some exemplary embodiments, the body 120 has a capacity to hold five (5) gallons of water, ten (10) gallons of water, or any capacity therebetween, whether potable or not potable water. Yet in other exemplary embodiments, the capacity may be less than five (5) gallons or greater than ten (10) gallons of water so long as the body 120 is portable. For example, the capacity of the body 120 may be too much for a person to lift, but the body 120 may accommodate wheels (not shown) at the bottom to facilitate moving the portable cooler hand-washing station 100 from one location to another location when full of water. The body 120 can be fabricated using a plastic material, such as a heavy duty, thick-walled plastic. In some embodiments, the body 120 can be fabricated using a rubberized material, a metal or metal alloy material, or some other suitable material used in fabricating coolers. The body 120 can include a base 121 and a sidewall 122 extending substantially orthogonal from the base 121 to form a body opening 423 (FIG. 4) at the distal ends of the sidewall 122, thereby defining a cavity (not shown) within the body 120 that is fluidly coupled to the body opening 423 (FIG. 4). According to certain exemplary embodiments, the body opening 423 (FIG. 4) is circular in shape and the cavity (not shown) is cylindrical in shape. In certain exemplary embodiments, the body 120 forms a spigot recess 125 at a bottom portion of the body 120 and at least one handle recess 126 along the middle to upper portion of the body 120. In exemplary embodiments where two handle recesses 126 are formed in the body 120, the handle recesses 126 are generally formed approximately 180 degrees apart. A spigot opening 427 (FIG. 4) is formed within the spigot recess 125 to allow for the spigot 180 to be coupled to the body 10 and allow the spigot 180 to be fluidly coupled to the water or other fluid contained within the body 120.

The lid 110 is a circular disc in shape according to an exemplary embodiment but may be shaped in any other geometric or non-geometric shape to cover the shape of the body opening in other embodiments. According to some exemplary embodiments, the lid 110 is fabricated using a plastic material, such as a heavy duty, thick-walled plastic. In some embodiments, lid 110 can be fabricated using a rubberized material, a metal or metal alloy material, or some other suitable material used in fabricating cooler lids. The lid 110 includes a base 111 and an outer sidewall 112 and an inner sidewall 413 (FIG. 4), both sidewalls 112, 413 (FIG. 4) extending substantially orthogonal from the base 111 and parallel to one another. The inner sidewall 413 (FIG. 4) is disposed within the cavity (not shown) of the body 120. The outer sidewall 112 is disposed either on top of the distal ends of the sidewall 122 of the body 120 or adjacently around the outer portion of the distal ends of the sidewall 122. Hence, the distal ends of the sidewall 122 are disposed within a space formed between the outer sidewall 112 of the lid 110 and inner sidewall 413 (FIG. 4) when the lid 110 is coupled to the top end of the body 120. In certain exemplary embodiments, the lid 110 forms at least one lid recess 115 at a distal end of the outer sidewall 112 of the lid 110. In exemplary embodiments where two lid recesses 115 are formed in the lid 110, the lid recesses 115 are generally formed approximately 180 degrees apart. The lid recesses 115 can be formed to facilitate a user in opening and decoupling the lid 110 from the body 120 to gain access to the inner portion of the body 120, which can be for filling up or emptying the contents from the body 120. Further, in certain exemplary embodiments, the base 111 of the lid 110 includes an outer surface 116 that faces away from the base 121 of the body 120 when the lid 110 is coupled to the body 120. The outer surface 116 can be generally flat and allow for a user to sit on the lid 110 or to place items on top of the lid 110 when the lid 110 is coupled to the body 120. The lid 110 can be coupled and decoupled to or from the body 120 by friction fit and either pressing down on the lid 110 or pulling up on the lid 110. In some examples, the lid 110 can be coupled or decoupled from the body 120 through rotation where the body 120 and the lid 110 include threads. Further, latches, hinges or other fasteners can be used for coupling and decoupling the lid 110 to and from the body 120.

A mounting bracket 260 can be an elongated rail that includes a base 261 and a rail 262 at opposite longitudinal sides of the base 261. The mounting bracket 260 can be coupled to the sidewall 122 of the body 120 using a screw (not shown) or some other fastening device such as a rivet. The screw (not shown) can be fastened through the base 261 of the mounting bracket 260 and into the sidewall 122 of the body 120. According to some embodiments, one or more screws (not shown) can be used to couple the mounting bracket 260 to the body 120. The mounting bracket 260 can be fabricated using a plastic material, such as a heavy duty, thick-walled plastic. In some embodiments, the mounting bracket 260 can be fabricated using a rubberized material, a metal or metal alloy material, or some other suitable material used in fabricating mounting brackets. According to some exemplary embodiments, one end of the mounting bracket 260, the end that is closer to the base 121 of the body 120 once the mounting bracket 260 is coupled to the body 120, includes a stopper (not shown) so that the caddy 170 stops sliding in a downwardly direction when being slidably coupled to the mounting bracket 260.

The caddy 170 can be a substantially rectangular container that includes a base 171 and an inner sidewall 172, external sidewall 173, and two lateral sidewalls 174, 175 extending from the base 171 to define a caddy opening 176 at the distal ends of the sidewalls 172, 173, 174, 175. The base 171 and the sidewalls 172, 173, 174, 175 define a caddy cavity 277 therein which is fluidly coupled to the caddy opening 176. The inner sidewall 172 can be formed into a shape that complements the exterior shape of the sidewall 122 to where the caddy 170 is to be coupled thereto. The inner sidewall 172 can include a caddy bracket 278 that complements with the mounting bracket 260 in a sliding relationship. The caddy bracket 260 can be adapted to couple the caddy 170 to the mounting bracket 260 in a sliding relationship. The bottom end of the caddy bracket 278 can be positioned over the top end of the mounting bracket 260 and adapted to be slid downwardly along the rails 262 of the mounting bracket 260 until the caddy 170 no longer moves in a downward position. According to some exemplary embodiments, the top end of the caddy bracket 278 includes a caddy stop feature 279, which extends along the top end of the caddy bracket 278. This caddy stop feature 279 can be used to provide a stop so that the caddy 170 does not continue to move downwardly with respect to the mounting bracket 260 when coupling the caddy 170 to the mounting bracket 260. According to some exemplary embodiments, the base 171 includes one or more openings 271 to allow for liquids trapped in the caddy cavity 277 of the caddy 170 to drain outwardly from the caddy 170. The caddy 170 can be designed to allow a top-pump soap dispenser 105 and/or a hand sanitizer 106 to be inserted through the caddy opening 176 and into the caddy cavity 277 where it may rest on the base 171 of the caddy 170. The caddy 170 may be dimensioned to allow for only one soap dispensing bottle or hand sanitizer bottle or for multiple bottles, as shown in the exemplary embodiment. Although not shown, a slidable divider (not shown) may be coupled to the external sidewall 173, which can be used to position and secure a top-pump soap dispenser 105 or a hand sanitizer 106.

The spigot 180 can include a conduit 181, a spout 182, or a lever 183 that controls fluid flow between the conduit 181 and the spout 182. The conduit 181 can be cylindrically shaped and be coupled to the body 120 within the spigot recess 125 and inserted through the spigot opening 427 (FIG. 4). The conduit 181 can be couplably sealed with the body 120 so that fluid within the body 120 can flow through the conduit 181 without leaking, which is known how to do by those people having ordinary skill in the art at the time of the invention and is therefore not described in detail herein. The lever 183 can be manually operated to control the flow of fluid from the conduit 181 to the spout 182 where a user can access the fluid for washing hands with the soap. The lever 183 can be operated without the use of hands, such as by the wrist, arm or elbow to name a few. When the lever 183 is physically actuated in an upward position, or flipped up, the lever 183 remains in that position and allows for full continuous flow from the conduit 181 and through the spout 182. When the lever 183 is physically actuated in a downward position, or flipped down, the lever 183 can remain in that position as long as the force applied to the lever 183 is present. In this downward position, the lever 183 can provide for regulated flow of the fluid from the conduit 181 through the spout 182. Once the force depressing the lever 183 is stopped, the lever 183 can move to its normal state and the flow of fluid from the conduit 181 through the spout 182 can stop. The spigot 180 used in the exemplary embodiment can be a BODA Faucet, Model A8, which is fabricated and sold by Boda Electrical Appliances Co., Ltd. having an address at No. 242 Ba Zi Qiao Xin Xin Village, Yu Yao Industrial Area, Zhejiang Province, China 315480, or any suitable spigot such as those that can provide for continuous flow.

The one or more handles 190 can be fabricated using a plastic material, such as a heavy duty, thick-walled plastic. In some other embodiments, the handles 190 may be fabricated using a rubberized material, a metal or metal alloy material, or some other suitable material used in fabricating handles. The handles 190 are coupled to the body 120 within the handle recesses 126 using screws or other known fasteners. The handles 190 can allow a user to lift the portable cooler hand-washing station 100 and move it from one location to another.

FIG. 4 is a perspective exploded view of the portable cooler hand-washing station 100 of FIG. 1 in accordance with the exemplary embodiment. The various components of the portable cooler hand-washing station 100 can be seen, including the body 120, the lid 110, the mounting bracket 260, the caddy 170, the spigot 180, and the handles 190. According to certain exemplary embodiments, a liner 440 can be included in the portable cooler hand-washing station 100.

The liner 440 is cylindrical in shape according to the exemplary embodiment but may be shaped in any other geometric or non-geometric shape in other embodiments. The outer surface of the liner 440 generally conforms in shape with an inner surface of the body 120 such that the liner 440 is insertable into the body 120. According to some exemplary embodiments, the liner 440 has a capacity to hold five (5) gallons of water, ten (10) gallons of water, or any capacity therebetween, whether potable or not potable water. Yet in other exemplary embodiments, the capacity may be less than five (5) gallons or greater than ten (10) gallons of water so long as the portable cooler hand-washing station 100 remains portable. For example, the capacity of the liner 440 may be too much for a person to lift, but the body 120 may accommodate wheels (not shown) at the bottom to facilitate moving the portable cooler hand-washing station 100 from one location to another location when full of water. The liner 440 can be fabricated using a plastic material, such as a heavy duty, thick-walled plastic. In some examples. the liner 440 can be fabricated using a rubberized material, a metal or metal alloy material, or some other suitable material used in fabricating cooler liners. The liner 440 can include a base 441 and a sidewall 442 extending substantially orthogonal from the base 441 to form a liner opening 443 at the distal ends of the sidewall 442, thereby defining a cavity 444 within the liner 440 that is fluidly coupled to the liner opening 443. According to certain exemplary embodiments, the liner opening 443 is circular in shape and the cavity 444 is cylindrical in shape. A liner aperture (not shown) is formed at the bottom portion of the sidewall 442 and is aligned with the spigot opening 427 once the liner 440 is inserted into the cavity of the body 120. In the embodiments where a liner 440 is present, the spigot 180 is coupled to the body 120 and the liner 440 in a manner where the spout 182 is fluidly coupled to the cavity 444 of the liner 440 through the spigot opening 427 and the liner aperture (not shown), thereby allowing the spout 182 to be fluidly coupled to the contents within the liner 440. According to some exemplary embodiments, an insulation (not shown), such as Styrofoam®, air, gel, carboard, or some other insulating material is disposed between the liner 440 and the body 120.

The portable cooler hand-washing station 100 can be moved from one location to another where there is a need to provide a hand-washing station or water. For example, the portable cooler hand-washing station 100 can be used in a remote environment, job site, school yard, playground, or any similar type place where there is no running water available. A person who desires to wash his or her hands or some other object can use the soap or sanitizer that is placed within the caddy 170, use his or her hands, wrist or other body part to flip the lever 183 to turn the water flow on from the interior of the portable cooler hand-washing station 100. The person can wash his or her hands or other object and then turn the water off by physically actuating the lever 183. This allows for use of non-potable water, if desired, to wash hands and save on drinking water for actual drinking. This portable cooler hand-washing station 100 can allow for hand-free operation to significantly reduce germs and other contamination of the spout 182 that can be spread from one user to the next.

Accordingly, many modifications and other embodiments set forth herein will come to mind to one skilled in the art to which portable cooler hand-washing stations pertain having the benefit of the teachings presented in the foregoing descriptions and the associated drawings. Therefore, it is to be understood that these portable cooler hand-washing stations are not to be limited to the specific embodiment disclosed and that modifications and other embodiments are intended to be included within the scope of this application. Although specific terms are employed herein, they are used in a generic and descriptive sense only and not for purposes of limitation.

In addition to the forgoing, the various embodiments of the present disclosure include, but are not limited to, the embodiments set forth in the following clauses.

Clause 1. A portable cooler hand-washing station, comprising: a body comprising a base and a sidewall extending orthogonally away from the base to form an opening at a distal end of the sidewall and define a cavity therein that is fluidly coupled to the opening, the body further defining a spigot opening at a lower portion of the body; a lid being coupled to the body and enclosing the cavity and the opening; a mounting bracket coupled to the sidewall of the body; a caddy comprising a base and a sidewall extending orthogonally away from edges of the base to form an opening at the distal end of the sidewall and define a caddy cavity therein that is fluidly coupled to the opening, the caddy cavity accommodating at least one of a soap dispenser or a hand sanitizer, the caddy being coupleable to the mounting bracket; and a spigot comprising a lever controlling a flow of a fluid through the spigot, the spigot coupled to the body at the spigot opening and being fluidly coupled to an interior of the body.

Clause 2. The portable cooler hand-washing station of clause 1, wherein the lever is adapted to be physically actuated in a hands-free manner.

Clause 3. The portable cooler hand-washing station of clause 1 or 2, wherein the lever is adapted to be flipped up to provide for flow of a fluid from within the cavity of the body through the spigot.

Clause 4. A portable cooler hand-washing station, comprising: a body comprising a base and a sidewall extending orthogonally away from the base to form an opening at a distal end of the sidewall and define a cavity therein that is fluidly coupled to the opening, the body further defining a spigot opening at a lower portion of the body; a mounting bracket coupled to the sidewall of the body; a caddy adapted to be coupled to the mounting bracket; and a spigot coupled to the body at the spigot opening, the spigot adapted to be fluidly coupled to an interior of the body.

Clause 5. The portable cooler hand-washing station of clause 4, wherein the caddy comprises a substantially rectangular container.

Clause 6. The portable cooler hand-washing station of clause 4 or 5, wherein the caddy defines a caddy cavity adapted to accommodate at least one of a soap dispenser or a hand sanitizer.

Clause 7. The portable cooler hand-washing station of any of clauses 4-6, wherein the caddy comprises an inner sidewall that is formed into a shape that complements an exterior shape of the sidewall of the body.

Clause 8. The portable cooler hand-washing station of any of clauses 4-7, wherein the caddy being adapted to be coupled to the mounting bracket comprises the inner sidewall comprising a caddy bracket that is adapted to couple the caddy to the mounting bracket in a sliding relationship.

Clause 9. The portable cooler hand-washing station of any of clauses 4-8, wherein a bottom end of the caddy bracket is adapted to be positioned over a top end of the mounting bracket.

Clause 10. The portable cooler hand-washing station of any of clauses 4-9, wherein the bottom end of the caddy bracket is adapted to be slid downwardly along at least one elongated rail of the mounting bracket.

Clause 11. The portable cooler hand-washing station of any of clauses 4-10 wherein a top end of the caddy bracket comprises a caddy stop feature adapted to provide a stop so that the caddy is prevented from moving downwardly with respect to the mounting bracket when the caddy is coupled to the mounting bracket.

Clause 12. The portable cooler hand-washing station of any of clauses 4-11, wherein the caddy stop feature extends along the top end of the caddy bracket.

Clause 13. The portable cooler hand-washing station of any of clauses 4-12, further comprising: a lid being coupled to the body and enclosing the cavity and the opening.

Clause 14. The portable cooler hand-washing station of any of clauses 4-13, wherein the spigot is adapted to be fluidly coupled to the interior of the body through a liner.

Clause 15. The portable cooler hand-washing station of any of clauses 4-14, wherein the spigot comprises a lever adapted to control a flow of a fluid through the spigot.

It is emphasized that the above-described examples of the present disclosure are merely examples of implementations to set forth for a clear understanding of the principles of the disclosure. Many variations and modifications can be made to the above-described examples without departing substantially from the spirit and principles of the disclosure. All such modifications and variations are intended to be included herein within the scope of this disclosure.

What is claimed is:

1. A portable cooler hand-washing station, comprising:
a body comprising a base and a sidewall extending orthogonally away from the base to form an opening at a distal end of the sidewall and define a cavity therein that is fluidly coupled to the opening, the body further defining a spigot opening at a lower portion of the body;
a lid being coupled to the body and enclosing the cavity and the opening;
a mounting bracket coupled to the sidewall of the body;
a caddy comprising a base and a sidewall extending orthogonally away from edges of the base to form an opening at the distal end of the sidewall and define a caddy cavity therein that is fluidly coupled to the opening, the caddy cavity accommodating at least one of a soap dispenser or a hand sanitizer, the caddy being coupleable to the mounting bracket; and
a spigot comprising a lever controlling a flow of a fluid through the spigot, the spigot coupled to the body at the spigot opening and being fluidly coupled to an interior of the body.

2. The portable cooler hand-washing station of claim 1, wherein the lever is adapted to be physically actuated in a hands-free manner.

3. The portable cooler hand-washing station of claim 1, wherein the lever is adapted to be flipped up to provide for flow of a fluid from within the cavity of the body through the spigot.

4. A portable cooler hand-washing station, comprising:
a body comprising a base and a sidewall extending orthogonally away from the base to form an opening at a distal end of the sidewall and define a cavity therein that is fluidly coupled to the opening, the body further defining a spigot opening at a lower portion of the body;
a mounting bracket coupled to the sidewall of the body;
a caddy adapted to be coupled to the mounting bracket; and
a spigot coupled to the body at the spigot opening, the spigot adapted to be fluidly coupled to an interior of the body.

5. The portable cooler hand-washing station of claim 4, wherein the caddy comprises a substantially rectangular container.

6. The portable cooler hand-washing station of claim 4, wherein the caddy defines a caddy cavity adapted to accommodate at least one of a soap dispenser or a hand sanitizer.

7. The portable cooler hand-washing station of claim 4, wherein the caddy comprises an inner sidewall that is formed into a shape that complements an exterior shape of the sidewall of the body.

8. The portable cooler hand-washing station of claim 7, wherein the caddy being adapted to be coupled to the mounting bracket comprises the inner sidewall comprising a caddy bracket that is adapted to couple the caddy to the mounting bracket in a sliding relationship.

9. The portable cooler hand-washing station of claim 8, wherein a bottom end of the caddy bracket is adapted to be positioned over a top end of the mounting bracket.

10. The portable cooler hand-washing station of claim 9, wherein the bottom end of the caddy bracket is adapted to be slid downwardly along at least one elongated rail of the mounting bracket.

11. The portable cooler hand-washing station of claim 8, wherein a top end of the caddy bracket comprises a caddy stop feature adapted to provide a stop so that the caddy is prevented from moving downwardly with respect to the mounting bracket when the caddy is coupled to the mounting bracket.

12. The portable cooler hand-washing station of claim 11, wherein the caddy stop feature extends along the top end of the caddy bracket.

13. The portable cooler hand-washing station of claim 4, further comprising:
a lid being coupled to the body and enclosing the cavity and the opening.

14. The portable cooler hand-washing station of claim 4, wherein the spigot is adapted to be fluidly coupled to the interior of the body through a liner.

15. The portable cooler hand-washing station of claim 4, wherein the spigot comprises a lever adapted to control a flow of a fluid through the spigot.
